(19) United States
(12) Patent Application Publication
(10) Pub. No.: US 2024/0091653 A1
(43) Pub. Date: Mar. 21, 2024

(54) Anonymous Leaderboard Based on Non-Fungible Tokens

(71) Applicant: International Business Machines Corporation, Armonk, NY (US)

(72) Inventors: Sneha Kanaujia, Lexington, MA (US); Al Chakra, Apex, NC (US); Bryan Childs, Poughkeepsie, NY (US); GREGORY C. CREMINS, Poughkeepsie, NY (US); Travis Biro, Cold Spring, NY (US); Andrew C. M. Hicks, Highland, NY (US); Cecilia Carranza Lewis, San Jose, CA (US); Peter G. Spera, Pleasant Valley, NY (US)

(21) Appl. No.: 17/945,223

(22) Filed: Sep. 15, 2022

(51) Int. Cl. A63F 13/798; A63F 13/46; H04L 9/00

(52) U.S. Cl. CPC A63F 13/798; A63F 13/46; H04L 9/50; A63F 2300/558

(57) ABSTRACT

An anonymous leaderboard for a monitored computing environments is provided. In response to an entity registering with the monitored computing environment (MCE), an encrypted identity and a dynamic non-fungible token (NFT) are generated for the registered entity, where the dynamic NFT has an associated blockchain technology data structure. The blockchain technology data structure is associated with the encrypted identity. A progress element notification is received from the MCE in response to the entity satisfying criteria for a predefined progress element associated with the MCE. In response, a static NFT, corresponding to the predefined progress element, is generated and stored as a block in the blockchain technology data structure. An entry in an anonymous leaderboard output is generated based on the blockchain technology data structure, where the entry identifies the entity by the encrypted identity.

### BACKGROUND

The present application relates generally to an improved data processing apparatus and method and more specifically to an improved computing tool and improved computing tool operations/functionality for providing an anonymous leaderboard based on non-fungible tokens.

A blockchain is a distributed digital ledger or database that guarantees the fidelity and security of a record of data and can be trusted without having to use trusted third party authentication mechanisms. The blockchain collects data into blocks that hold sets of information which are linked to previously generated blocks, thereby forming a chain of data, hence the term “blockchain”. Any new data that is subsequently generated for the blockchain will be compiled into a newly generated block, having a corresponding timestamp, which is then added to this chain and linked to the previously generated block(s). This creates an immutable timeline of data which can be utilized in a decentralized manner. Blockchains are often used as ledgers for transactions and providing cryptocurrency mechanisms and can be used to provide non-fungible tokens.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided that generates an anonymous leaderboard for a monitored computing environment. The method comprises generating, in response to an entity registering with the monitored computing environment, an encrypted identity for the registered entity. The method also comprises generating a dynamic non-fungible token (NFT) for the registered entity, where the dynamic NFT has an associated blockchain technology data structure, and associating the blockchain technology data structure with the encrypted identity. The method further comprises receiving a progress element notification from the monitored computing environment in response to the entity satisfying criteria for a predefined progress element associated with the monitored computing environment. In response to receiving the progress element notification, the method generates a static NFT corresponding to the predefined progress element and storing the static NFT as a block in the blockchain technology data structure. Moreover, the method comprises generating an entry in an anonymous leaderboard output based on the blockchain technology data structure of the dynamic NFT, wherein the entry identifies the entity by the encrypted identity.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of the primary operational components of a computer managed anonymous leaderboard platform in accordance with one illustrative embodiment;

FIG. 2A is a flowchart outlining an example operation for generating and automatically updating a dynamic non-fungible token (NFT) corresponding to an entity represented in a computer managed anonymous leaderboard platform of a monitored computing environment in accordance with one illustrative embodiment;

FIG. 2B is a flowchart outlining an example operation for generating an anonymous leaderboard output in accordance with one illustrative embodiment;

FIGS. 3A-3C provide an example of one implementation of the computer management anonymous leaderboard platform and dynamic/static NFTs with regard to a card based video game computing environment in accordance with one illustrative embodiment; and

FIG. 4 is an example diagram of a distributed data processing system environment in which aspects of the illustrative embodiments may be implemented and at least some of the computer code involved in performing the inventive methods may be executed.

### DETAILED DESCRIPTION

The illustrative embodiments provide an improved computing tool and improved computing tool operations/functionality that provides anonymous leaderboard management capabilities based on non-fungible tokens, such as those provided through a Markov chain or blockchain technology. As noted above, blockchain provides a distributed immutable ledger of transactions. With blockchain technology, a node in a distributed data processing system, e.g., a computing device operating as node in a wide area network (WAN) or local area network (LAN), initiates a transaction and sights it with its private key and then a block representing the transaction is generated on the blockchain platform. The transaction is broadcast to peer nodes within the network based on preset criteria and these peer nodes validate the transaction, such as through a consensus algorithm or the like. After the peer nodes validate the transaction, the block is included in the blockchain and the transaction is confirmed. The adding of the block to the blockchain involves linking the block to the previous block through a cryptographic linking.

Because the blockchain is immutable, the transactions represented by the blocks in the blockchain, and the data for those transactions in the blockchain, may be trusted without having to invoke a third party authentication mechanism. Moreover, the blockchain may be distributed to a large number of computing nodes in the network, thereby avoiding the single failure of failure database mechanisms of other database or electronic ledger mechanisms.

Blockchain technology is an implementing technology for providing non-fungible tokens (NFTs) for uniquely certifying digital assets. As is apparent, when a digital asset is created, the number of copies of that digital asset that may be generated as a result is virtually infinite. This poses a problem for the creator of the digital asset to realize the value of their original creation as the value is significantly diminished as the number of copies increases, the transferability is increased, etc. NFTs provide a mechanism for controlling the copying and transferability of a digital asset by providing a mechanism to uniquely identify a individual instance of the digital asset, e.g., the originally created digital asset.

That is, a NFT provides a unique digital signature mechanism that can uniquely identify a digital asset, i.e., NFTs can make a digital asset, such as a digital image of a work of art, a digital recording of a musical composition, an in-game item within a video game, a digital video, or the like, a “one-of-a-kind” type digital asset as the NFT uniquely identifies a single instance of a digital asset and thus, a unique ownership of the digital asset. NFTs are not interchangeable as they have unique identifying codes. This is in contrast to fungible tokens which are interchangeable and can be converted to smaller units that combine to provide the same amount or value as the original fungible token. A NFT stores specific information about the asset that it represents, such as ownership information, transaction information (sale of the asset), etc.

NFTs may be provided as both static NFTs and dynamic NFTs. A static NFT identifies and authenticates a single digital asset (simply referred to as an “asset” hereafter). Examples include digital artifacts, badges, or similar certifications. A dynamic NFT identifies dynamic assets which are assets that can be amended, expanded, or contracted. An example of such a dynamic asset is a catalog of an individual's skill set or capabilities. As new skills are accrued, the certifications associated with these skills become a part of the NFT and the addition is represented along the blockchain of the dynamic NFT. Because these associate with a specific entity, these are also non-transferrable as well as non-fungible.

The illustrative embodiments leverage, modify, augment, and combine the capabilities of digital NFTs and blocktree/blockchain technologies in a novel manner with regard to leaderboard mechanisms and specifically providing an anonymous leaderboard computing tool and corresponding anonymous leaderboard computing tool operations/functionality that has not previously been provided by existing leaderboard computer functionality. Computer leaderboards (hereafter referred to simply as “leaderboards”) are used in a variety of computer managed activities to relatively rank participants in those activities. These activities may include gaming activities, such as digital video games, sporting activities, workplace activities, e.g., sales achievements, or the like. For example, in many online video games, players of the video game achieve points through performing various actions within the video game and these points may be used to rank the players relative to one another, thereby providing a leaderboard functionality which players may view to determine their relative performance to other players and attempt to get to the top of the leaderboard. Leaderboards are often used as an incentivizing mechanism to appeal to participants innate sense of competition by causing the participants to try to out-perform other participants. Similarly, in workplace environments, computing systems may be utilized to monitor or track employee skill sets, educational certifications, skill certifications, employment based achievements, or the like, and such achievements may be used to rank employees relative to one another in a leaderboard. Similar examples exist in the educational environment where students may achieve different grades or scores on tests, projects, or other educational task, and may achieve other educational achievements, e.g., attendance, good citizenship awards, etc., and be ranked relative to their peers in a leaderboard.

It should be appreciated that while the activities and participants, in some illustrative embodiments, may not be within a computing environment, e.g., a human athlete engaged in a sports competition, the computerized management of the leaderboard for those activities is within the computing environment and it is the leaderboard computing tool and leaderboard computing tool operations/functionality that is the focus of the present invention. Thus, while human beings may be the subject of the leaderboard, and may make use of the leaderboard, generated by the leaderboard computing tool of the illustrative embodiments, they are not integral to the operations and functions actually performed by the leaderboard computing tool itself as these are operations and functions that are automatically performed by the leaderboard computing tool itself without human intervention.

Current computer or digital leaderboard mechanisms explicitly identify the participants represented in the leaderboard's relative rankings. While this identification may be through pseudonyms or identifiers that are not the participants specific name, e.g., using “gamertags” or the like, they can be relatively easily correlated to the actual participants' specific name through other mechanisms, such as account mappings from gamertag to registered user account, or the like. Thus, for example, a leaderboard may list out the top 5 players of a video game based on their corresponding identifiers, listing out their scores or points, achievements reached, and the like, such that anyone that knows or has access to a mapping of the identifiers to actual real-world users, can personally identify the real-world users, entities, or the like, that are represented in the leaderboard. Thus, there is no, or very limited, privacy capability in the existing computer managed leaderboard mechanisms.

The lack of, or very limited offerings of, privacy within a computer managed leaderboard is problematic in situations where the individuals or entities represented by the identifiers in entries of the leaderboard wish to control their privacy yet still be represented in the leaderboard rankings. The individual/entity may be a single person, a computing device or computing system, an organization, a group of individuals, or any other entity that may be represented by an identifier in a computer managed leaderboard. For purposes of this description hereafter, these entities will be considered to be individual users for ease of explanation but not limitation, i.e., any entity that may be represented in a leaderboard is considered to be within the spirit and scope of the present invention.

For example, in the case of educational or organizational achievements, it may be desirable to individuals to not have their identities made public until the individual/entity decides to do so. This is especially the case for individuals that may be performing at a relatively lower ranking than other individuals, e.g., students that score poorly on tests with the results of the test performance being provided by ranking on a leaderboard accessible by the students. The student in this example, may not wish for his/her peers to know how poorly the student did relative to other students and thus, may wish to remain anonymous so as to avoid ridicule. Similar considerations may apply to job performance in an employment environment, game performance in a computer game environment, or the like.

Similarly, for privacy reasons, an individual doing well relative to other individuals in the leaderboard rankings may wish to remain anonymous to avoid unwanted attention, unwanted attempts to contact, etc. For example, in an online gambling scenario, an individual may not want others to know how much the individual has won and attempt to contact that individual. There are a plethora of situations in which entities represented by entries in a computer managed leaderboard may wish to remain anonymous and have control over if and when their identities are made public.

In a competing interest, individuals may also wish to be able to prove that they are uniquely identifiable with an entry in a computer managed leaderboard, i.e., an individual is in fact the one and only person represented by the particular entry in the computer managed leaderboard. For example, a user may wish to prove that they are the top ranked player of a particular video game and that no other individual can verifiably claim to be the individual associated with that entry in the computer managed leaderboard. Thus, individuals want to be able to have anonymity until the point in time when they decide to publicly disclose their identity, and then be able to have verifiable proof that they are the unique individual associated with a corresponding entry in the computer managed leaderboard.

The present invention provides an improved computing tool and corresponding improved computing tool operations/functionality that provides anonymity in the entries of a computer managed leaderboard, while providing mechanisms for unique and immutable proof of the correlation between an identity specified in an entry of the computer managed leaderboard with a particular entity, e.g., a user, video game player, organization, or the like. The illustrative embodiments provide static NFTs that represent the achievements and/or elements measuring a level of progress (referred to as “progress elements”) on a corresponding computer managed leaderboard. The illustrative embodiments provide dynamic NFTs that represent entities that may own or otherwise be associated with the static NFTs. For example, in a video gaming environment, static NFTs may be used to represent instances of achievements within the video game, e.g., performing certain actions such as acquiring a certain number of items within the video game, while the dynamic NFT may represent the video game player themselves.

The static NFTs provide unique and immutable representations of the particular instances of progress elements associated with a corresponding entity, e.g., individual, while the dynamic NFT provides a unique and immutable representation of the entity, such as via a Markov chain, blockchain, or blocktree mechanism, which may be dynamically modified to include static NFTs that are generated for progress elements acquired or otherwise associated with the entity. Thus, as an entity acquires progress elements, corresponding static NFTs are generated and these may be used to add blocks to the blockchain in the dynamic NFT representing the entity. The dynamic NFT may be associated with a unique identifier that is encrypted within the dynamic NFT. The encrypted identifier is also used to represent the entity on the outputs of the leaderboard and/or in response to a request to view the progress elements associated with the encrypted identifier, i.e., viewable by other entities. The only entity that has access to the encryption key to decrypt the encrypted identifier is the entity themselves Thus, in both the dynamic NFT and the representations of the computer managed leaderboard, the entity is only referenced through an encrypted identifier that cannot be decrypted without express authorization by the entity themselves through providing the private decryption key.

In this way, the entity is anonymous in the representation of the leaderboard and in the presentation of the progress elements associated with the encrypted identifier. The entity has control over if and when to present their actual identification, such as by providing a decryption of the encrypted identifier. Moreover, as the dynamic NFT uses a blockchain to represent the original encrypted identifier as a block in the blockchain and each subsequent progress element acquired or associated with that encrypted identifier, the entity's ability to decrypt the identifier presents a unique and immutable proof that the entity is in fact the entity represented by the encrypted identifier and with which the progress elements are associated. Anyone else attempting to claim to be the entity associated with the encrypted identifier will not be able to decrypt the identifier because they do not have access to the private key and also will not be able to create a copy of the dynamic NFT that is validated because of the unique and immutable nature of the static NFTs and blockchain that compose the dynamic NFT.

As noted above, the anonymous leaderboard computing tool of the illustrative embodiments is built using static and dynamic NFTs. As an example interaction with an entity and description of how the anonymous leaderboard operates, consider a video gaming environment example. In this example, a user may sign up to play the video game by creating an account with a specified username and password, where the username may be considered the identifier of the entity, who in this case is the user playing the video game. The username may be encrypted using any suitable encryption algorithm, after which the user is provided with an encryption token which is the mechanism that allows the encrypted username can be decrypted, e.g., the encryption token may be a private encryption key or the like, that is stored in association with the user and is only accessible by the user, or those to which the user specifically provides the encryption token.

A new blockchain entry, i.e., block, associated with the encrypted username is created in the dynamic NFT representing the user. It should be appreciated that while the encrypted username is included in a block of the blockchain, it is included in its encrypted form and those that do not have access to the encryption token cannot access the username. It should also be appreciated that the dynamic NFT is publicly available and stored on multiple computing systems of one or more data networks, such as WANs, LANs, the Internet, and the like, in a distributed fashion. It should also be noted that while some illustrative embodiments include the encrypted username in an initial block of the dynamic NFT, this is not a requirement and instead other mechanisms may be utilized to associate the dynamic NFT with the encrypted username or identity of the user without having to store the encrypted username or identity in an initial block of the blockchain technology data structure. For example, the initial block may comprise a link that points to another data structure in which the encrypted username or identity is present.

When the user completes a task or otherwise progresses according to the tasks, achievements, events, or the like (collectively referred to herein as “progress elements”), tracked by the anonymous leaderboard computing tool with regard to the video game in this example, a static NFT of the progress element is automatically generated and added as a block in the blockchain of the dynamic NFT representing the user. The automatically generated static NFT has an associated timestamp indicating a time when the user achieved the progress element, e.g., claimed an achievement in the video game, and information specifying characteristics of the progress element. In some illustrative embodiments, the characteristics of the progress element may include a rarity of the progress element being achieved and/or claimed within the video game, e.g., how many times it has been claimed, such as by other users, prior to this user claiming it, a determination of how easy/difficult it is for users to claim the achievement, etc. By collecting rarer NFTs, the user's relative “ranking” within the anonymous leaderboard will increase at a greater amount or frequency, e.g., rarer achievements may be associated with a relatively higher increase in ranking than less rare achievements. It should be appreciated that while this gaming example is provided with regard to achievements or other progress elements being achieved, acquired, or otherwise claimed by a user, the illustrative embodiments are not limited to such. Rather, in other instances scoring points for performing activities within the video game may also be provided with each session of the game, or each play of the game, causing a corresponding block in the blockchain to be generated in which the progress element may be the score for that session or play, an accumulation of scores over multiple sessions or plays, or the like. Any indicator of progress may be a progress element used as a basis for generating an anonymous leaderboard with relative rankings of entities within the leaderboard.

Any user/organization can use a leaderboard query engine to view the blockchain of static NFTs collected by the user and see characteristics of the static NFTs, such as the timestamp, rarity, and other information about the progress elements are represented by the corresponding static NFTs. However, even in gaining access to the information maintained in the static NFTs of the blockchain of a dynamic NFT representing the user, other users and organizations still are not able to access the username encrypted in the encrypted username of the initial block in the blockchain, i.e., the username remains encrypted. In this way, the users/organizations may see that encrypted username “XYZ” has claimed a specific set of achievements represented by static NFTs in the blockchain, but still is not able to correlate encrypted username “XYZ” with an actual username, or with the actual real-world user. These users/organizations may also utilize the leaderboard query engine to see the global ranking of users via a public leaderboard output, such as via a website or the like, but the identities of the entities on the leaderboard will also remain encrypted, i.e., the encrypted usernames may be utilized rather than the usernames themselves. Only if the user agrees to present their identity in an unencrypted manner will the public leaderboard output represent them by their decrypted username rather than the encrypted username.

If a user wishes to prove their identity within the public leaderboard output, the user may control presentation of the unencrypted username via decryption of the unencrypted username in the blockchain using their privately held encryption token. Thus, by having the encryption token and using it to decrypt the encrypted username in the blockchain, and by virtue of the fact that the blockchain is immutable, it can be verified that the user is in fact the real-world entity represented by the dynamic NFT and initial block in the blockchain of the dynamic NFT. This provides an immutable verification of the identity of the user and immutable association of progress elements with this user via the blockchain and encrypted username present in the original block of the blockchain.

Thus, the illustrative embodiments provide an anonymous leaderboard computing tool and anonymous leaderboard computing tool operations/functionality for anonymous, verifiable leaderboards implemented in association with computer managed leaderboards for tracking progress and relative rankings of participants in various activities. The anonymous leaderboard promotes positive competition between entities while maintaining privacy of the entities.

Again, while the illustrative embodiments will be described with regard to a video gaming environment, it is important to recognize that the illustrative embodiments are not limited to only leaderboards used in video gaming environments. To the contrary, the computer managed leaderboards may be used in environments where relative progress of participants is tracked and ranked relative to one another for various activities including sales goal achievement, educational achievements, employment skill certifications, etc. The illustrative embodiments are intended to be encompassing of any environment in which a computer managed leaderboard mechanism is provided and which is augmented with the mechanisms of the illustrative embodiments to provide an anonymized leaderboard functionality, which again has not been provided by existing computer managed leaderboard mechanisms. Thus, while some illustrative embodiments will be described hereafter with an example of an educational electronic card game in which players a progress by acquiring electronic cars of various rarities based on their demonstration of skill, proficiency, and the like, of a given subject matter, the illustrative embodiments are not limited to such.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

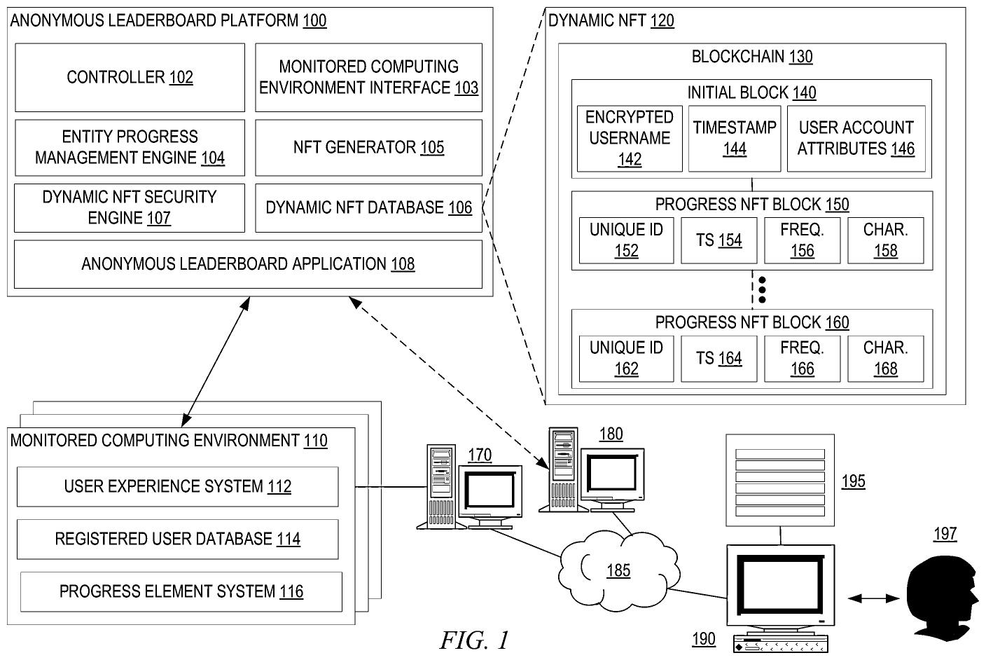

FIG. 1 is an example block diagram of the primary operational components of a computer managed anonymous leaderboard platform in accordance with one illustrative embodiment. As shown in FIG. 1, the computer managed anonymous leaderboard platform 100 comprises a controller 102, a monitored computing environment interface 103, an entity progress management engine 104, a non-fungible token (NFT) generator 105, a dynamic NFT database 106, a dynamic NFT security engine 107, and an anonymous leaderboard application 108. The controller 102 provides the computer logic for facilitating and orchestrating the operation of the other elements 103-108 of the computer managed anonymous leaderboard platform 100 and providing interfaces, e.g., application programming interfaces (APIs) and infrastructure for communication and interaction between these other elements 103-108. The controller 102 may access other underlying mechanisms, such as libraries, data structures, and the like (not shown), which are used to provide the orchestration and interaction of the elements 103-108.

The monitored computing environment interface 103 provides a data communication interface between the anonymous leaderboard platform 100 and the monitored computing environment(s) 110. The anonymous leaderboard platform 100 operates with the monitored computing environment(s) 110 to provide the anonymous leaderboard operations/functionality, specifically with regard to the entities, e.g., users, groups, organizations, etc., that are to be represented in the leaderboard for the monitored computing environment(s) 110. It should be appreciated that while the anonymous leaderboard platform 100 of the illustrative embodiments is shown as a separate entity from the monitored computing environment(s) 110 for purposes of emphasizing aspects of the illustrative embodiments, such separation is not required for the illustrative embodiments and the anonymous leaderboard platform 100 may in fact be integrated into the monitored computing environment(s) 110, such as having a separate instance of the anonymous leaderboard platform 100 provided for each different monitored computing environment 110. That is, for example, in some illustrative embodiments, different monitored computing environments 110 may have their own instance of the anonymous leaderboard platform 100 which is specifically configured to monitor and provide anonymous leaderboard operations/functionality specifically with regard to the particular entities associated with that particular monitored computing environment 110. In some illustrative embodiments, the anonymous leaderboard platform 100 may be provided as a separate computing tool from the monitored computing environment(s) 110 and may operate to provide anonymous leaderboard operations/functionality for one or more monitored computing environments 110 via appropriate data communication interfaces and connections, such as via the monitored computing environment interface 103 and one or more data networks 185.

The entity progress management engine 104 provide computer executed logic to automatically monitor entity progress within the monitored computing environment 110 via the monitored computing environment interface 103. As entities acquire or are assigned progress elements within the monitored computing environment 110, the entity progress management engine 104 identifies those changes in progress element acquisitions/assignments and captures and maintains progress element characteristic data about those progress elements from the monitored computing environment 110. Thus, for a newly acquired/assigned progress element for a particular user, the entity progress management engine 104 is notified by the monitored computing environment 110 that a user corresponding to an encrypted username acquired/was assigned the progress element and the entity progress management engine 104 captures the characteristics data for that instance of the progress element. The progress element characteristic data may include individual progress element instance characteristics, e.g., encrypted username of entity that acquired/was assigned the progress element, progress element type, timestamp that progress element was acquired/assigned, progress element requirements, etc., for the particular instance of the progress element. This instance characteristic data may be used to create/update global progress element characteristics of the progress element type maintained by the entity progress management engine 104, e.g., progress element frequency of acquisition/assignment, such as a count of a number of times the progress element has been acquired/assigned to entities, or the like. Other examples of global progress element characteristics may include achievement, achievement level, rank (who reached the achievement first, second etc.), quality (how well the achievement was achieved, the level of achievement), quantity (the number of times or the number of achievements acquired over a similar topic, number of achievements acquired over a certain amount of time), and the like. For example, a single instance of a “hunter” achievement, within a monitored computing environment 110 representing a video game in which users may find artifacts in a simulated game environment, may be acquired by a user after acquiring a particular number of artifacts of a particular type, and this achievement may be an entity progress element having various characteristics, such as one or more of those described above.

The entity progress management engine 104 captures this information and maintains and updates global progress element characteristics for this progress element type. The entity progress management engine 104 provides the instance specific characteristics and updated global progress element characteristics to the NFT generator 105 that operates to generate a static NFT for the progress element instance and to retrieve a corresponding dynamic NFT, e.g., dynamic NFT 120, from the dynamic NFT database 106 to which the static NFT, e.g., progress NFT block 160, is added as part of its blockchain 130. The NFT generator 105 generates the static NFT for the progress element and stores it in the blockchain 130 of the dynamic NFT 120 which is stored in the dynamic NFT database 106 and used to provide the anonymous leaderboard via the anonymous leaderboard application 108.

That is, during registration with the monitored computing environment 110, the entity, e.g., user 197, sets up an account with the monitored computing environment 110 through known methods and interactions via their computing device 190, data network(s) 185, and server 170, or data processing system comprising a plurality of computing devices, which hosts the monitored computing environment 110, and in some illustrative embodiments, the anonymous leaderboard platform 100. As noted above, in some illustrative embodiments, the anonymous leaderboard platform 100 may otherwise be provided via a separate computing device, such as server 180, or data processing system comprising a plurality of computing devices. In such an embodiment, the anonymous leaderboard platform 100 may communicate with the monitored computing environment 110 via the data network(s) 185 and server 170, or corresponding data processing system comprising a plurality of computing devices.

In setting up the account, the user 197 specifies various registration information through an account setup interface of the monitored computing environment 110, which may include specifying an identifier for the user 197, e.g., username, and security information for maintaining the account secure, e.g., a password. In addition, other personal information about the user may also be provided, such as residence information, payment details, and the like. Once registration is complete, a user account data structure is added to the registered user database 114 and the user is provided access to the user experience system 112. The user experience system 112 provides a user experience with which progress elements are associated, but may be of various types depending on the desired implementation. For example, the user experience system 112 may provide a video game that the user 197 wishes to play, may provide an education environment in which the user 197 performs actions to educate themselves about one or more topics and achieves/is assigned progress elements based on their progress in educating themselves, may provide an employment environment through which the user 197 performs their job functions and/or reports results of performing their job functions, which may result in progress elements being achieved/assigned to the user 197, or the like.

In some illustrative embodiments, the user experience system 112 provides a multi-user environment and is configured to provide an associated leaderboard within the user experience system 112 for use by the users 197 to track their relative progress. In other illustrative embodiments, instances of the user experience system 112 may be generated for each user 197 individually, but progress via a leaderboard mechanism may span multiple ones of these instances and multiple different users. As shown in FIG. 1, in some illustrative embodiments, the anonymous leaderboard platform 100 may operate in conjunction with multiple different monitored computing environments 110, and may provide an anonymous leaderboard operation/functionality for each separate monitored computing environment 110 individually, or in some cases a combined anonymous leaderboard operation/functionality that spans multiple ones of the different monitored computing environments 110 such that entities from a plurality of different monitored computing environments 110 may be ranked relative to one another.

The monitored computing environment 110 is configured to communicate with its corresponding anonymous leaderboard platform 100 which provides the anonymous leaderboard of registered users in the registered user database 114 for that monitored computing environment 110. When a user 197 registers with the monitored computing environment 110, the monitored computing environment 110 provides the user's identity to the dynamic NFT security engine 107 of the anonymous leaderboard platform 100 for generation of an encrypted identity, e.g., encrypted username, for the user and provide back a unique encryption token that is stored in the user's computing device 190 for later use. The encrypted identity, e.g., encrypted username, is also provided to the NFT generator 105 which generates a dynamic NFT, e.g., dynamic NFT 120, with a corresponding initial block 140 of a blockchain 130. In some illustrative embodiments, the initial block 140 is a static NFT storing the encrypted username 142, the timestamp associated with the time when the user account was setup, and optionally other user account attributes 146. This information may be stored as a tuple data structure within the initial block 140.

As the user 197 operates within the monitored computing environment 110 and the user experience system 112, the user's actions and achievements are monitored via the user experience system 112 and progress element system 116, which may be used to associate progress elements to the user 197 based on results of this monitoring. For example, in a video game user experience system 112, the user's actions within the video game may be monitored with respect to a set of predefined progress elements to determine if the user 197 satisfies one or more criteria of the progress elements and thus, should be assigned the corresponding progress element. For example, if a criterion of a progress element is to gather X number of an item within the video game, and the user achieves this number of items being gathered, then the progress element system 116 will determine that the user 197 has achieved the progress element, e.g., award, achievement, or the like, and will associate the progress element with the user's account in the registered user database 114. In addition, the progress element system 116 is configured to notify the anonymous leaderboard platform 100 of the user 197 having acquired or been assigned the progress element, e.g., specifying the username and corresponding progress element details such as progress element name, unique progress element instance identifier, progress element type, out-of-user experience system rarity and/or an in-user experience system 112 rarity measure, or the like. In some illustrative embodiments, the out-of-user experience system rarity may be, for example, a statistical measure of how rare the progress element is based on the number of times the progress element was actually achieved by users. In some illustrative embodiments, the in-user experience system rarity may be a rarity assigned to the particular progress element by the user experience system itself, e.g., acquiring a particular in-game achievement, such as finding all the legendary artifacts, may be a very rare achievement, however all users have the potential to achieve that very rare achievement. In some illustrative embodiments, the rarity may be one or both of these types of out-of-user experience system and in-user experience system rarities.

The data from the reporting by the progress element system 116 of the monitored computing environment 110 of the acquisition/assignment of the progress element to the user 197 is provided to the entity progress management engine 104 which invokes the dynamic NFT security engine 107 to encrypt the username to generate an encrypted username and perform a lookup of the encrypted username in the dynamic NFT database 106 to find the corresponding dynamic NFT 120 for the user 197. The entity progress management engine 104 uses the data in the progress element report to update global characteristics for the progress element, e.g., a global count of the number of times this progress element has been achieved/assigned within the monitored computing environment 110. The entity progress management engine 104 further invokes the NFT generator 105 to generate a static NFT representing the progress element and add it to the blockchain 130 of the matching dynamic NFT 120 that matches the encrypted username 142.

The static NFT 160 comprises a tuple of a unique identifier 162 for the progress element instance associated with the user 197, a timestamp (TS) 154 when the progress element instance was associated with the user 197, e.g., a timestamp of when the user achieved the achievement or award, a rarity or frequency (Freq.) 166 of association of the progress element with users, and in some illustrative embodiments other characteristics 168 of the progress element instance. In some illustrative embodiments, the rarity or frequency characteristic 166 of the static NFT 160 may be a combination of the user experience system 112 specified rarity and the global rarity characteristic maintained by the entity progress management engine 104. For example, in some user experience systems 112, a uniqueness or rarity is specified by the number of instances within the user experience system 112 itself, e.g., in some video games, items have different rarities of “dropping” when users perform particular actions. This rarity is specified by the mechanics of the user experience system 112 itself. The global rarity characteristic maintained by the entity progress management engine 104 is an additional rarity measure that determines a frequency of occurrence or rarity of how often users actually acquired or are assigned the progress element, e.g., how many times a user actually acquires the item. By combining both rarity measures, the rarity or frequency characteristic 166 specifies not only how rare the progress element is within the user experience 112, but also how rare the progress element is among actual users 197 of the user experience system 112.

The blocks 140-160 form a blockchain 130 in which each block is linked to the previous block in the blockchain 130 in an immutable manner. Thus, the blockchain 130 comprises static NFT blocks 150-160 which uniquely specifies the particular combination of progress element instances associated with an entity, and the entity itself is uniquely specified in the initial block 140. The initial block 140 stores the encrypted identity of the entity and this encrypted identity is not able to be decrypted except by use of the encryption token provided to the entity and stored in the entity's computing system, e.g., computing device 190 of user 197.

The anonymous leaderboard application 108 access the dynamic NFT database 106 for entities associated with the monitored computing environment 110 and generates an anonymous leaderboard output that relatively ranks entities based on their corresponding progress elements represented by the static NFTs of their corresponding dynamic NFTs. That is, for each entity associated with a monitored computing environment 110, the entity's corresponding dynamic NFT 120 is retrieved and the static NFT blocks 150-160 are used to generate a ranking measure for the entity. The ranking measures are the ordered relative to one another to obtain a leaderboard ranking for the various entities. For example, the anonymous leaderboard application 108 may comprise scoring logic that generates a quantifiable value representing the progress elements associated with entities, where this quantifiable value may be based on at least the rarity of frequency characteristics 156, 166 of the progress static NFT blocks 150-160, with more rare or less frequently associated progress static NFT blocks 150-160 providing a greater quantifiable value than less rare or more frequently associated progress static NFT blocks 150-160. The ranking measure may combine the quantifiable values of all the progress static NFT blocks 150-160 associated with the entity to thereby generate an overall ranking measure that is compared to other overall ranking measures of other entities to thereby relatively rank the entities within the anonymous leaderboard generated by the anonymous leaderboard application 108.

The anonymous leaderboard application 108, in generating the anonymous leaderboard output, has access to, and utilizes, only the anonymized dynamic NFTs 120 in the dynamic NFT database 106 and does not have access to the actual identifiers, e.g., usernames, of the specific entities themselves. As a result, the anonymous leaderboard application 108 represents the entities as the anonymized identifiers, e.g., encrypted usernames 142. As there is no mapping between the anonymized identifier, e.g., the encrypted username, and a particular entity maintained in the monitored computing environment 110, the anonymous leaderboard platform, or elsewhere, it is not possible for a third party to breach the anonymity of the entity representations in the anonymized leaderboard and gain access the true identity of the entity, e.g., user 197. That is, the anonymized leaderboard generated by the anonymous leaderboard application may specify the encrypted username 142 specified in the initial block 140 of the blockchain 130 of the dynamic NFT 120, in association with the relative ranking and/or other progress element characteristics, depending on the desired implementation, e.g., the name/type of the progress element, the rarity or frequency of the progress element, etc.

The anonymized leaderboard output may be generated by the anonymous leaderboard application 108 and provided either directly to the entities, e.g., user 197, via an interface, webpage, or the like, separate from the monitored computing environment 110, e.g., via server or data processing system 180 and data network(s) 185. For example, the user 197 may access a webpage or website provided by server 180 to render the anonymized leaderboard 195 in their web browser application on their client computing device 190. Alternatively, the anonymized leaderboard output may be provided to the monitored computing environment 110 which may have a leaderboard interface through which users of the monitored computing environment 110 may access the anonymized leaderboard via their client computing device 190, the data network(s) 185, and server or data processing system 170. For example, an interface may be provided “in-game” such that a video game user experience system 112 may provide a graphical user interface element for access the anonymized leaderboard output so that a user can check their relative ranking from within the video game. It should be appreciated that even though the anonymized leaderboard output may be accessible by multiple entities, e.g., users 197, via their computing devices 190, the entities represented in the anonymized leaderboard are represented by their anonymized identities, e.g., encrypted usernames. Each individual entity, e.g., user 197, may be aware of their own anonymized identity, but others will not be aware of the association of a anonymized identity with the true identity of the entity unless the entity discloses it.

With regard to disclosure of an entity's true identity, the anonymous leaderboard application 108 may provide an option for an entity, e.g., user 197, to de-anonymize their representation in the leaderboard output by providing a corresponding encryption token. That is, the entity, e.g., user 197, may submit a request to disclose or prove their identity within the anonymized leaderboard output and may submit the encryption token along with the request to the anonymous leaderboard application 108, where the request may specify the particular entry in the anonymous leaderboard output that is to be de-anonymized. The anonymous leaderboard application 108 may invoke the dynamic NFT security engine 107 to decrypt the encrypted identity corresponding to the specified entry in the anonymized leaderboard output. If the encryption token is valid, then the encrypted identity is decrypted and the decrypted identity is used by the anonymous leaderboard application 108 to re-render the anonymized leaderboard output with the entry being de-anonymized, i.e., the decrypted identifier being used in place of the encrypted identifier. This mapping of the decrypted identifier to the encrypted identifier may be stored for a temporary time period, which may be specified by the entity in the request to de-anonymize, during which renderings of the anonymized leaderboard output will represent the entity in a decrypted form. However, after this time period is expired, the mapping is removed within the anonymous leaderboard application 108 and subsequent representations of the entity within anonymous leaderboard outputs will again utilize the anonymous identifier, e.g., encrypted username. Hence, the entity, e.g., user 197, may temporarily disclose their identity, such as to prove that they are the true entity that is associated with the particular entry in the leaderboard and have achieved the progress elements specified in the leaderboard entry. Moreover, the entity controls if and when such disclosure is made, and for how long.

Thus, the present invention provides an improved computing tool and corresponding improved computing tool operations/functionality that provides anonymity in the entries of a computer managed leaderboard, while providing mechanisms for unique and immutable proof of the correlation between an identity specified in an entry of the computer managed leaderboard with a particular entity, e.g., a user 197, video game player, organization, or the like. The illustrative embodiments provide static NFTs 150-160 that represent the achievements and/or progress elements measuring a level of progress on a corresponding computer managed leaderboard. The illustrative embodiments provide dynamic NFTs 120 that represent entities, e.g., user 197, that may own or otherwise be associated with the static NFTs 150-160. For example, in a video gaming environment, static NFTs 150-160 may be used to represent instances of achievements within the video game provided by the user experience system 112 of a monitored computing environment 110, e.g., performing certain actions such as acquiring a certain number of items within the video game, while the dynamic NFT 120 may represent the video game player themselves.

The static NFTs 150-160 provide unique and immutable representations of the particular instances of progress elements associated with a corresponding entity, while the dynamic NFT 120 provides a unique and immutable representation of the entity which may be dynamically modified to include new static NFTs 150-160 that are generated for progress elements acquired or otherwise associated with the entity. Thus, as an entity acquires progress elements, corresponding static NFTs 150-160 are generated and these may be used to add blocks 150-160 to the blockchain 130 in the dynamic NFT 120 representing the entity. The dynamic NFT 120 may be associated with a unique identifier 142 that is encrypted within the dynamic NFT 120. The encrypted identifier 142 is also used to represent the entity on the outputs, e.g., 195, of the leaderboard and/or in response to a request to view the progress elements associated with the encrypted identifier 142, i.e., viewable by other entities. The only entity that has access to the encryption token to decrypt the encrypted identifier is the entity themselves, e.g., the encryption token is stored in the entity's computing device 190 or data processing system. Thus, in both the dynamic NFT 120 and the representations of the computer managed leaderboard, the entity is only referenced through an encrypted identifier 142 that cannot be decrypted without express authorization by the entity themselves through providing the private decryption token.

In this way, the entity is anonymous in the representation of the leaderboard 195 and in the presentation of the progress elements associated with the encrypted identifier. The entity has control over if and when to present their actual identification, such as by providing a decryption of the encrypted identifier. Moreover, as the dynamic NFT 120 uses a blockchain to represent the original encrypted identifier as a block in the blockchain and each subsequent progress element acquired or associated with that encrypted identifier, the entity's ability to decrypt the identifier presents a unique and immutable proof that the entity is in fact the entity represented by the encrypted identifier and with which the progress elements are associated. Anyone else attempting to claim to be the entity associated with the encrypted identifier will not be able to decrypt the identifier because they do not have access to the private key and also will not be able to create a copy of the dynamic NFT that is validated because of the unique and immutable nature of the static NFTs and blockchain that compose the dynamic NFT.

As noted above, the anonymous leaderboard computing tool of the illustrative embodiments is built using static and dynamic NFTs 120 and 140-160. As an example, consider a video gaming environment example where the user experience system 112 provides a video game accessible by the user 197 and other users (not shown), such as a massively multiplayer online (MMO) game. In this example, a user 197 may sign up to play the video game 112 by creating an account with a specified username and password, where the username may be considered the identifier of the entity, who in this case is the user 197 playing the video game. The username may be encrypted using any suitable encryption algorithm by the dynamic NFT security engine 107 to generate an encrypted username 142, after which a the user is provided with an encryption token which is the mechanism that allows the encrypted username 142 can be decrypted, e.g., the encryption token may be a private encryption key or the like, that is stored in association with the user and is only accessible by the user, or those to which the user specifically provides the encryption token.

A new blockchain entry, i.e., initial block 140, associated with the encrypted username 142 is created in the dynamic NFT 120 representing the user 197. It should be appreciated that while the encrypted username 142 is included in the initial block 142 of the blockchain 130, it is included in its encrypted form and those that do not have access to the encryption token cannot access the username. It should also be appreciated that the dynamic NFT 120 is publicly available and stored on multiple computing systems of one or more data networks 185, such as WANs, LANs, the Internet, and the like, in a distributed fashion.

When the user completes a task or otherwise progresses according to the tasks, achievements, events, or the like (collectively referred to herein as “progress elements”), tracked by the anonymous leaderboard computing platform 100 and progress element system 116 of the monitored computing environment 110 with regard to the video game 112 in this example, a static NFT 150-160 of the progress element is automatically generated and added as a block 150-160 in the blockchain 130 of the dynamic NFT 120 representing the user. The automatically generated static NFT 150-160 has an associated timestamp 154, 164 indicating a time when the user 197 achieved the progress element, e.g., claimed an achievement in the video game, and information specifying characteristics 152, 156-158, 162, 166-168 of the progress element. In some illustrative embodiments, the characteristics of the progress element may include a rarity (or frequency) 156, 166 of the progress element being achieved and/or claimed within the video game 112, e.g., how many times it has been claimed prior to this user claiming it, a determination of how easy/difficult it is for users to claim the achievement, etc. By collecting rarer NFTs, the user's relative “ranking” within the anonymous leaderboard will increase at a greater amount or frequency, e.g., rarer achievements may be associated with a relatively higher increase in ranking than less rare achievements.

Any user/organization can use a leaderboard query engine provided via the monitored computing environment 110, client browser on a client computing device 190, or the like, to view the anonymous leaderboard output 195 and the blockchain 130 of static NFTs 140-160 of entries in the anonymous leaderboard output 195 to look at the collected progress elements of an anonymized entity and see characteristics of the static NFTs 140-160, such as the timestamp 154, 164, rarity 156, 166, and other information 152, 158, 162, 168 about the progress elements which are represented by the corresponding static NFTs 140-160. However, even in gaining access to the information maintained in the static NFTs 140-160 of the blockchain 130 of a dynamic NFT 120 representing the user 197, other users and organizations still are not able to access the username encrypted in the encrypted username of the initial block 140 in the blockchain 130, i.e., the username remains encrypted. In this way, the users/organizations may see that encrypted username “XYZ” has claimed a specific set of progress elements, e.g., achievements, represented by static NFTs 150-160 in the blockchain 130, but still is not able to correlate encrypted username “XYZ” 142 with an actual username, or with the actual real-world user 197. These users/organizations may also utilize the leaderboard query engine to see the global ranking of users via a public leaderboard output 195, such as via a website or the like, but the identities of the entities on the leaderboard will also remain encrypted, i.e., the encrypted usernames may be utilized rather than the usernames themselves. Only if the user agrees to present their identity in an unencrypted manner will the public leaderboard output 195 represent them by their decrypted username rather than the encrypted username.

If a user wishes to prove their identity within the public leaderboard output 195, the user may control presentation of the unencrypted username via decryption of the unencrypted username 142 in the blockchain 130 using their privately held encryption token. Thus, by having the encryption token and using it to decrypt the encrypted username in the blockchain, and by virtue of the fact that the blockchain is immutable, it can be verified that the user is in fact the real-world entity represented by the dynamic NFT 120 and initial block 142 in the blockchain 130 of the dynamic NFT 120. This provides an immutable verification of the identity of the user 197 and immutable association of progress elements with this user 197 via the blockchain 130 and encrypted username 142 present in the original block 140 of the blockchain 130.

Thus, the illustrative embodiments provide an anonymous leaderboard computing tool and anonymous leaderboard computing tool operations/functionality for anonymous, verifiable leaderboards implemented in association with computer managed leaderboards for tracking progress and relative rankings of participants in various activities. The anonymous leaderboard promotes positive competition between entities while maintaining privacy of the entities.

As noted above, while examples are provided with regard to video gaming user experience systems 112, the illustrative embodiments are not limited to such. To the contrary, the user experience system 112 may provide other user experiences including employment monitoring experiences, educational experiences, and the like. Any user experience in which progress elements are used to gauge or track an entity's progress with regard to use or actions associated with the user experience may be used in conjunction with the anonymous leaderboard platform 100 of the illustrative embodiments. Moreover, in some illustrative embodiments, it should be appreciated that the actions themselves may not be performed within the monitored computing environment 110 but instead may be performed outside the monitored computing environment 110 but reported to the monitored computing environment via the progress elements system 116 either from other computing environments or by user entry of information specifying the actions performed. For example, if an employee performs actions outside a monitored computing environment that results in the employee being awarded an award (progress element), the awarding of the award may be reported to the progress element system 116 which may then initiate the mechanisms of the anonymous leaderboard platform 100 previously described above.

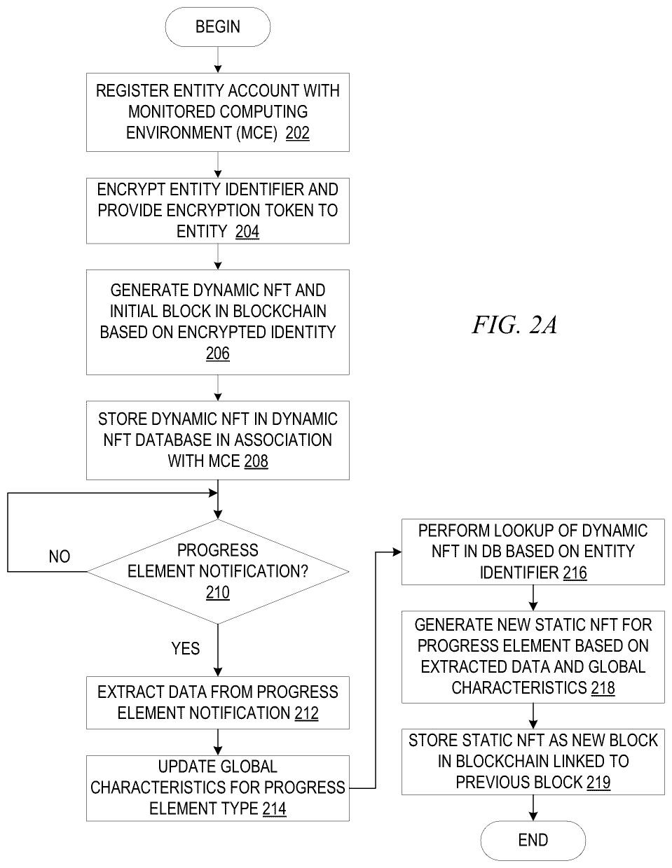

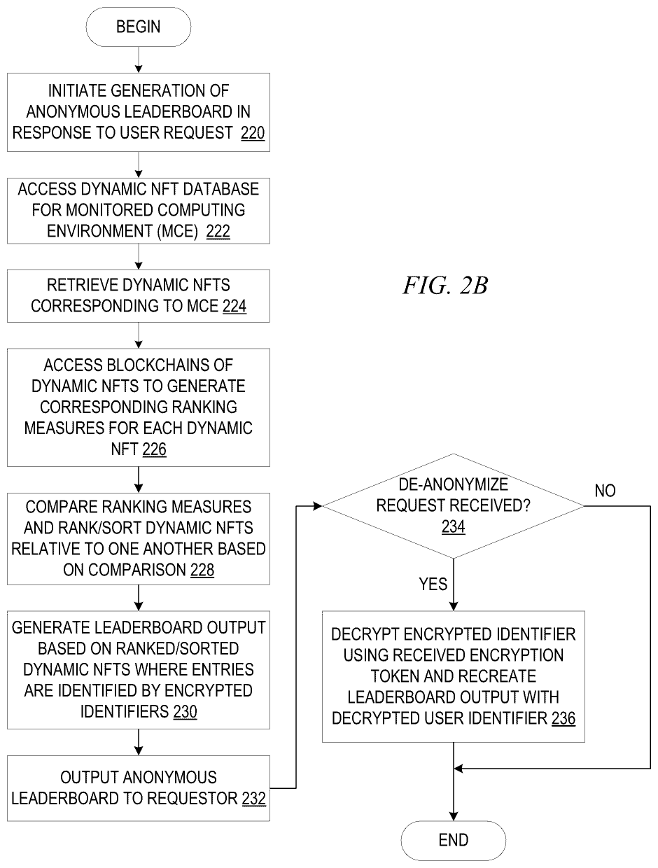

FIG. 2A is a flowchart outlining an example operation for generating and automatically updating a dynamic non-fungible token (NFT) corresponding to an entity represented in a computer managed anonymous leaderboard platform of a monitored computing environment in accordance with one illustrative embodiment. FIG. 2B is a flowchart outlining an example operation for generating an anonymous leaderboard output in accordance with one illustrative embodiment. The operation set forth in FIGS. 2A and 2B may be performed by the anonymous leaderboard platform 100 in FIG. 1, for example. It should be appreciated that the operations outlined in FIGS. 2A and 2B are specifically performed automatically by an improved computer tool of the illustrative embodiments and are not intended to be, and cannot practically be, performed by human beings either as mental processes or by organizing human activity. To the contrary, while, in some illustrative embodiments, human beings may initiate the performance of the operation set forth in FIGS. 2A and 2B and may make use of the results generated as a consequence of the operations set forth in FIGS. 2A and 2B, the operations in FIGS. 2A and 2B themselves are specifically performed by the improved computing tool in an automated manner.

As shown in FIG. 2A, the operation starts with the registration of an entity account with a monitored computing environment (step 202). An identifier of the entity account, e.g., a username, is encrypted and an encryption token is returned to the entity (step 204). The encrypted identity is then used to generate a dynamic NFT and initial block, as a static NFT, in a blockchain of the dynamic NFT (step 206). The dynamic NFT is stored in a dynamic NFT database in association with the monitored computing environment (step 208). Thereafter, the operation determines whether a notification is received of a progress element having been associated with the entity (step 210). In the case that no progress element notification is received, the operation continues to wait. In the case that a progress element notification is received from a progress element system of the monitored computing environment, the detailed information about the progress element instance is extracted from the progress element notification (step 212).

The extracted information is used to update one or more global characteristics for the corresponding progress element type (step 214). In addition, the extracted information includes the identifier of the entity that achieved or was assigned the progress element, which is encrypted and used as a basis for retrieving a corresponding dynamic NFT from the dynamic NFT database by matching the encrypted identity with entries in the database (step 216). A new static NFT representing the progress element is generated (step 218) and stored in a blockchain linked to a previous block in the blockchain of the retrieved dynamic NFT (step 219). As noted above, the static NFT may store a tuple of data regarding the progress element instance including, for example, a unique identifier of the progress element instance, a timestamp of when the progress element instance was associated with the entity, a frequency or rarity of the progress element being associated with entities within the monitored computing environment, and other characteristics of the progress element. The operation then terminates.

As shown in FIG. 2B, an operation for generating an anonymous leaderboard output may be invoked periodically, in response to a user request to access a leaderboard output via a graphical user interface element, web browser accessing a website associated with the leaderboard, or the like (step 220). In response to the request to access the leaderboard output, the anonymous leaderboard application accesses a dynamic NFT database for the monitored computing environment specified in the request (step 222) and retrieves dynamic NFTs corresponding to entities associated with that monitored computing environment (step 224). The anonymous leaderboard application accesses the blockchains associated with the retrieved dynamic NFTs and generates, for each dynamic NFT, a corresponding ranking measure based on characteristics of the progress elements associated with each dynamic NFT (step 226). As described above, this may involve, for example, evaluating the rarity/frequency characteristics of the progress elements represented by static NFTs in the blockchains of each of the dynamic NFTs, and calculating a ranking measure based on a scoring of each progress element. The ranking measures are compared to one another for all of the dynamic NFTs and ranked/sorted according to a desired ordering for the leaderboard, e.g., ascending or descending order of ranking measures, such that the ordered ranking measures provides a relative ranking of the corresponding dynamic NFTs (step 228). The entries in the resulting leaderboard are identified by the anonymized identifiers of the corresponding dynamic NFTs, e.g., the encrypted usernames specified in the initial block of the blockchain (step 230).

The anonymous leaderboard output is then output to the requestor (step 232) and a determination is made as to whether a de-anonymization of an entry in the anonymous leaderboard output is received (step 234). If not, the operation terminates. However, in response to the user sending a request to de-anonymize their entry in the anonymized leaderboard output, along with an encryption token for performing the de-anonymization and a time period for maintaining the de-anonymization, the anonymous leaderboard application decrypts the corresponding entry and updates the anonymous leaderboard output to represent the user according to their decrypted identity for a period of time specified in the request (step 236). The operation then terminates.

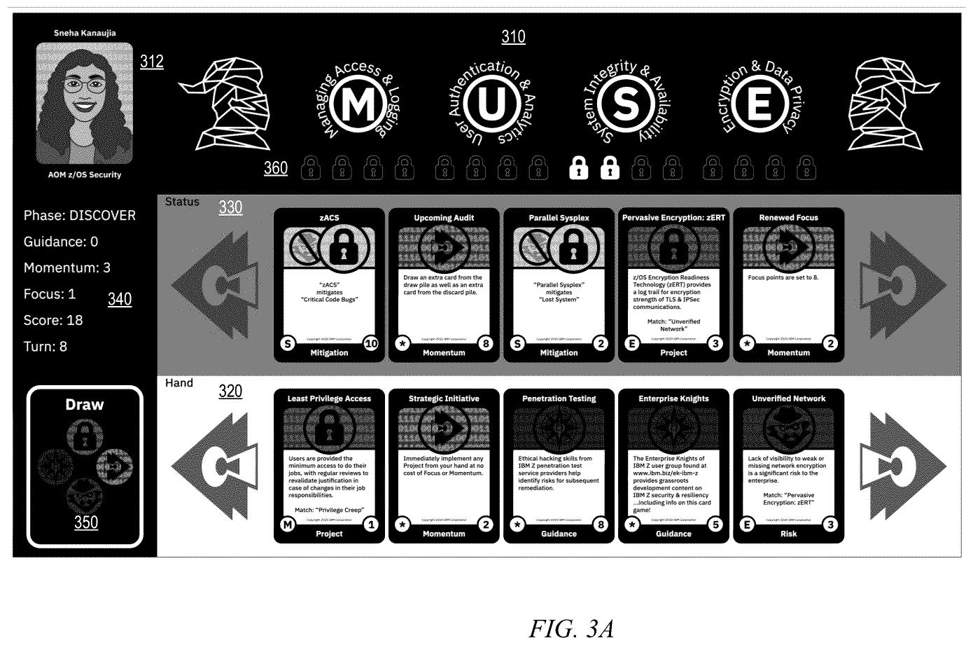

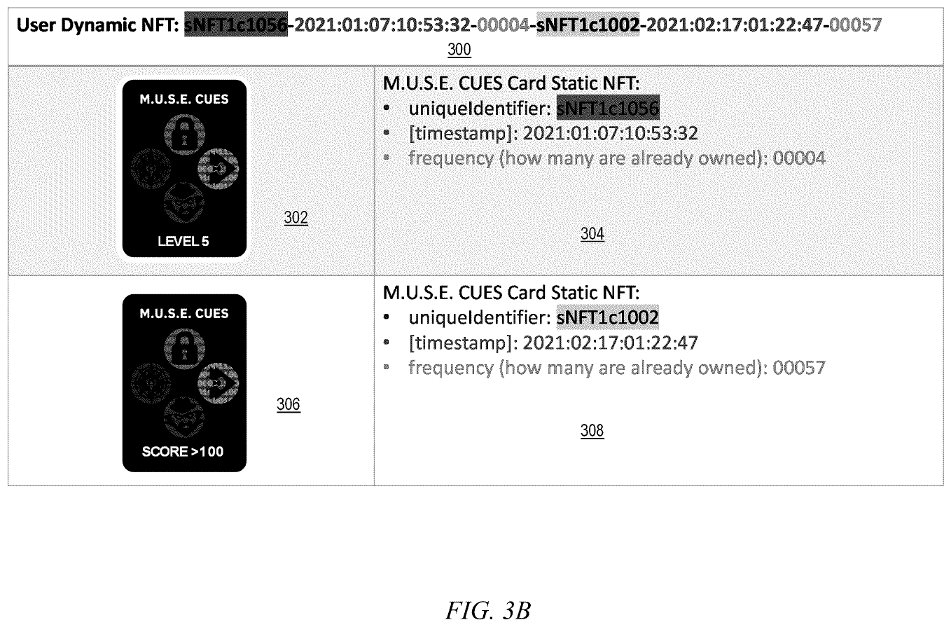

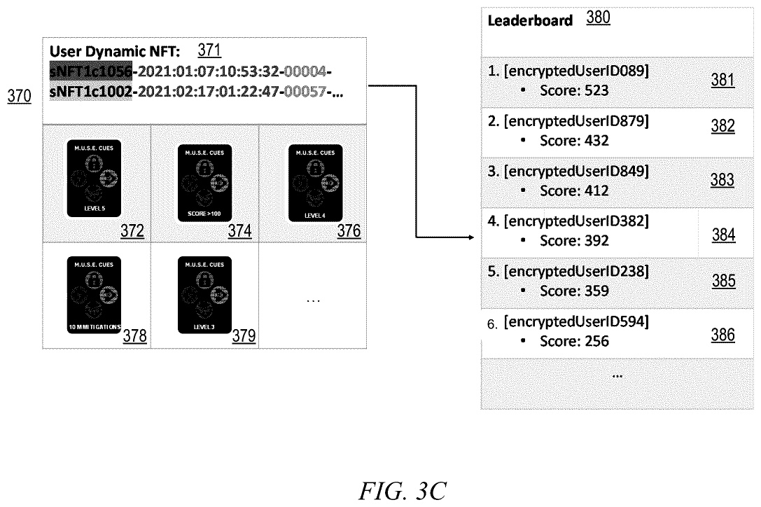

FIGS. 3A-3C provide an example of one implementation of the computer management anonymous leaderboard platform and dynamic/static NFTs with regard to a card based video game computing environment in accordance with one illustrative embodiment. In this particular example implementation, the digital card based video game computing environment is an educational video game designed to teach players about a cyber security framework in order to drive risk reduction. The example shown in FIGS. 3A-3C will be described first by describing the card based educational game, and then by showing how the elements of the anonymized leaderboard platform operate with regard to this digital card based educational video game. The digital card based educational video game is referred to herein as M.U.S.E. Cues, where each letter of the acronym references an aspect of cyber security, such as Managing access and Logging (M), User Authentication and Analytics (U), System Integrity and Availability (S), and Encryption and Data Privacy (E). It should be appreciated that this digital card game user experience system is used only as an example of one possible implementation of a user experience system in which an anonymous leaderboard may be utilized and provided by the mechanisms of one or more illustrative embodiments.

M.U.S.E. Cues Example Implementation

The following description is meant to be an overview of the M.U.S.E Cues digital card game and is not intended to be a step-by-step instruction manual for the game. The following description provides sufficient details for illustrating the digital card game with regard to the identification of progress elements and implementation of the anonymous leaderboard platform in conjunction with these progress elements of the M.U.S.E Cues card game. It should be appreciated that in this description, the acquired digital cards themselves operate as progress elements, with the rarity of the cards being a measure of the difficulty in achieving the progress element and providing a basis for generating a score for the player. It is these progress elements that may be represented as static NFTs in a blockchain of a dynamic NFT representing the player.

As a preface to the description of M.U.S.E. Cues, it should be appreciated that there are a variety of constructs to assess an enterprise's security posture, and there are a variety of compliance regulatory models as well. They are not typically specific to a particular platform and therefore, it can be challenging for both early tenure and experienced security architects to determine the greater risk, the next step of mitigation, and what platform-specific offerings would apply. Advocating best practices in security can be very subjective and can benefit from defense-in-depth strategies that look at the cyber security and resiliency posture holistically. Simplification is of key importance. Thus, there is a need to more effectively communicate and subsequently implement platform-relevant offerings that exceed the minimums of regulatory compliance.

Although the COVID era may be temporary, business leaders argue that it has changed both education and product marketing delivery methods perpetually. Education in general is more challenging in a COVID-cognizant, all-virtual environment, from the perspectives of capturing attention, keeping that attention, and seeing that educational message translating into action. This is certainly relevant for the area of cyber security and resiliency, for a variety of reasons. First, the increased level of world-wide agitation and discomfort feed into the methods of social engineering to steal user credentials and personal data. Second, virtual work environments present additional attack surfaces regarding the scale and potentially weaker end points of remote devices connecting into the respective places of work. Third, there is the potential in this environment to assume that data breach is inevitable, or that there is so much security-related technology to choose from, that enterprises may be inclined to defer to the minimal requirements of compliance regulations, where risk-based decision making could otherwise have mitigated or prevented such a breach.

M.U.S.E. Cues provides a specific form of gamified education to be used in improving the education and subsequent implementation of an improved cyber security and resiliency posture. While an example M.U.S.E. Cues implementation may reference various product and service offerings of the IBM Z platform, emphasizing the z/OS operating system, this is not intended to be a limitation but rather just an example that may be readily extended to any other platform. The construct is an online digital card game in which the goal of the game is to get players to consider the points in making sound decisions, e.g., risk-based decisions to improve cyber security and resiliency.

The M.U.S.E. acronym outlines a simple yet powerful security model framework comprising the aspects of a defense-in-depth strategy, which includes the combination of (M)anaging access & logging, (U)ser authentication & analytics, (S)ystem integrity & availability, and (E)ncryption & data privacy, all of which are fundamental aspects of cyber security and resiliency. It has long been a foundation of cyber security to cover Confidentiality, Integrity, and Availability, concepts found readily throughout cyber security publications. The topic of confidentiality can be readily split into a user's authentication and the access that the user is permitted to system resources. Access extends naturally into log records for both failures and successes. Large volumes of that log data subsequently feed security-related analytics to a user's activity, to discover possible attack attempts or alternatively, the abnormal activities of authenticated users as potential insider threats or possible intruders leveraging stolen credentials. These four aspects are therefore covered by the (M) and (U) of the M.U.S.E. acronym. Regarding the other two foundational aspects of integrity and availability, those have more to do with the state of the system itself, hence the (S) of (S)ystem integrity & availability. Confidentiality however is not limited to access controls. The (E) of Encryption complements and augments all of these activities, for both data in flight and data at rest, along with digital signature technologies helping to ensure that data has not been erroneously altered. Data privacy is a natural extension to this, rounding out the set of eight aspects, where the industry has shifted in recent years, as seen in several regulation bodies such as GDPR, to extend its purpose to protecting the privacy of individuals and businesses with respect to their protected data. There are many regulatory standards and cyber security framework organizations that exist, such as PCI DSS, HIPAA, ISO 27001, SOC 2, FIPS 140, NIST, and MITRE. The M.U.S.E. Cues digital card game can serve as an overall introduction to each of them.

Custom card games commonly have a variety of attributes to serve their game mechanics and overall theme. The M.U.S.E. Cues digital card game design leverages these attributes for the attention-retaining gaming benefits, as well as educational benefits to better advocate cyber security and resiliency in several unique ways including in the digital card layout, the suits of the digital cards, the points associated with the digital cards, the phases of the game itself, and the gaming metrics or keeping player scores.

With regard to card layout, the majority of the M.U.S.E. CUES playing cards share the same general layout. The digital card layout itself is similar to various card games, but a brief overview serves to explain the novel benefits of the related game mechanics. FIG. 3A shows an example of a video game interface in which a variety of different example digital cards, having the digital card layout described hereafter, are represented. As shown in FIG. 3A, the face of each digital card includes the following elements of a digital card layout:
(1) title (unique to each card), found in the header;
(2) logo (corresponding to the suit), circled atop the upper half, e.g., lock graphic, graphic of a thief, etc.;
(3) description (unique to each card), in the lower half;
(4) category (of M.U.S.E.), denoted by a single circled letter in the lower left; e.g., M, *, E, S, etc, (Note that a category value of ‘*’ means applicability to all of the M.U.S.E. categories); and
(5) point value, denoted by a circled number in the lower right; suit (1 of 4), found in the footer, corresponding to the logo, e.g., Momentum, Mitigation, Project, Guidance, etc.

There are four main suits in the M.U.S.E. CUES game represented by corresponding graphics and, in some illustrative embodiments, a corresponding different color of graphic (although the different colors are not represented in the depiction in FIG. 3A), A first suit represented by a compass graphic is the Guidance category that corresponds to a resource capacity for Risks (see below). second suit represented by a. key forward graphic refers to Momentum, which corresponds to a resource capacity card for Projects (see below). A third suit, Risk, is represented by a thief or hacker graphic and corresponds to a platform-agnostic security risk to be mitigated. A fourth suit, Project, is represented by a lock graphic and corresponds to a project to implement a security function to mitigate risk. The distinct graphics, and potentially colors, provide a visual reinforcement of the card suits and their purpose. These suits are further referenced visually with the “back” of the card, used in online gameplay actions such as “Draw”, “Advance”, & “Discard”, associated with various game phases (see the lower left corner of the associated diagram for an example of the “Draw” action gaming element). A fifth specialty suit, “Mitigation”, is also provided but follows a slightly different format in that it is created when a specific Risk card is matched with a corresponding Project card that mitigates that Risk.

The suits and their design reinforce multiple points in strengthening an enterprise's cyber security posture, as there are various forms of guidance that can be obtained to help an enterprise clearly identify risk. In cyber security, a specifically identified risk is the use case for specific security functionality. A project associated with implementing that functionality requires business justification and it takes some degree of momentum for that implementation to actually occur. Risk always exists. Implemented security functionality is a mitigation of risk. The suits of this digital card game therefore align with the progression of an enterprise mitigating risk. Other security-related card games are designed with a goal to break through defenses, while this digital card game is designed to assist in building them up.

Each digital card has a point value (shown in bottom right corner of the card), and the context of these points is dependent on the category. For example, for Guidance category cards, the point value adds capacity to help identify Risks. For Momentum category cards, the point value adds capacity to help complete Projects. For Risk category cards, the point value indicates the amount of capacity points required to identify the risk. For Project category cards, the point value indicates the amount of capacity points required to implement the project.

At the beginning of each turn, the player gains 1 Focus point. Focus points are leveraged whenever a player attempts to identify Risk without sufficient Guidance points, or to implement a Project without sufficient Momentum. if there is still an insufficient amount of combined capacity points, the respective Risk or Project card cannot be played. The gaming and advocacy benefits of these point values are described hereafter.

There are four phases to each turn of the game. These phases fit the style of various custom card games, as well as the general progression of business processes associated with Agile DevSecOps. In a first phase of the turn, referred to as the “Discover” phase, the player draws three random digital cards from the draw pile (represented in FIG. 3A as the “Draw” card 350 in the lower left portion of the depicted graphical user interface). In a second phase of the turn, referred to as the “Plan” phase, the player may play one Guidance or Momentum card, if in hand, i.e. in the Hand row 320, to increase corresponding points for future execution. For example, in the depiction in FIG. 3A, the player could move the Momentum card “Strategic Initiative”, from the Hand row 320 to the Status row 330 to thereby increase corresponding points for future execution.

In a third phase of the turn, referred to as the “Execute” phase, the player may play any number and any combination of Risk and Project cards, if in hand, and with sufficient points, moving each to the status of “identified Risk” and “implemented Project”, respectively, by moving the cards from the Hand row 320 to the Status row 330. For example, in FIG. 3A, there is a project card, “Pervasive Encryption: zERT”, that has been “implemented” as it has been moved from the Hand row 320 to the Status row 330. In the Hand row 320 there is a Risk card, “Unverified Network”, which has not been “identified” as it still remains in the Hand row 320, and not the Status row 330.

In a fourth phase of the turn, referred to as the “Reflect” phase, the player discards at least one card, with a maximum remaining hand of ten cards in the Hand row 320. The random nature of the Discover phase and the boundaries of the Reflect phase are part of the game, and also provide value to its replay ability, which therefore increases its educational value.

In business, metrics tend to drive behavior, and the same is certainly true for games. The M.U.S.E. Cues digital card game advocates and advances a holistic view of cyber security and resiliency. The M.U.S.E. Cues digital card game does this in a number of different ways directly related to the player's score, to advocate recommended actions. The M.U.S.E. Cues digital card game encourages the game to be played repeatedly to obtain higher scores, providing further educational value in that repetition.

For example, in the M.U.S.E. Cues digital card game, the implementation of a Project card increases the player's score by that point value. This affirms the concept that security is not stagnant and that implementing distinct security measures improves an enterprise's overall security posture. Prioritization can be subjective, and so Project card point values are based on their relative availability, to encourage awareness of a new function.

In addition, in the M.U.S.E. Cues digital card game, every Risk card that is randomly drawn into the player's hand constitutes a negative adjustment to the player's score according to its point value. Once a Risk is identified, that adjustment resets to 0. Identifying the Risk does not actually improve the security posture, comporting with the motto, “In cyber security, what you don't know, can hurt you.” The emphasis here is the value in clarifying risk so that it can be subsequently mitigated.

With regard to mitigating a specific risk use case, at a high-level, the M.U.S.E. Cues digital card game is a matching game. It provides educational value in understanding how a platform-agnostic risk is mitigated by a matching platform-specific offering or configuration to mitigate that risk. In the depicted example digital cards in FIGS. 3A-3C, the game is configured for IBM Z, with an emphasis on z/OS, but it readily feasible to implement for any platform. When a risk is identified and mitigated by the implementation by a matching project, the points associated with that project are doubled.

With regard to improving security holistically, with the M.U.S.E. Cues digital card game, whenever a set of mitigation cards is completed to spell M.U.S.E., that is, a new risk and project match for each of the four categories, a new multiplicative modifier is established for the remainder of the game. Spelling M.U.S.E. the first time establishes a ×2 modifier, the second ×4, the third ×8, and the fourth ×16. This encourages defense-in-depth, and also balances out the value of projects with smaller point values, as they take fewer points to implement and potentially make it easier to establish those modifiers quicker.

A primary advantage of this gamified education is to provide a high-level view of a holistic cyber security and resiliency posture. These online assets provide a variety of ways for the player to discover and explore topics in further depth, for whatever platform they serve (the focus of IBM Z being just one example).

In customizable card games, players often review all of their collected cards to help plan their strategies. That is certainly true in the design of M.U.S.E. Cues, where the entire deck of cards can be independently listed online for reference, with related links to related online documentation and videos that explore any given topic in further depth. Business decisions on project implementation frequently focus on the associated use case to determine their relative value, and in the area of cyber security where that use case is always some form of risk, this design provides a unique mechanism to explore specific mitigations for specific risks with a gamified overview of their context alongside other factors. The ability to link to traditional in-depth reference extends that value.

The M.U.S.E. Cues digital card game design also provides the ability for this in-depth information to be provided in-game. For example, over the course of online play, the player's actions are primarily in selecting specific cards with a left-mouse-click to move from one pile to another (from the draw pile to the hand, from the hand to the discard pile, or from the hand to the status bar). A right-mouse-click on any given Project card can instead bring up a separate web browser window listing related video, blog, and documentation details of that specific Project. Similarly, a right-mouse-click on any given Guidance card could bring up details on the actual expertise described, whether it's some re-occurring conference, service provider, or other reference. As a turn-based game, this would not adversely affect the gameplay. The player could study any given topic in-depth, and then return to the game for further insights on other topics.

Further, the M.U.S.E. Cues digital card game design, in support of any expanding technology platform, is easily extendable with new card combinations as new forms of risks are identified and new technologies are developed to mitigate those risks. These extensions may be given greater visibility in how they are displayed as part of a collection, and in-game with higher associated point values to draw further attention. The game mechanics and the visual design provides benefits in helping to identify emerging topics in cyber security and resiliency.

With reference again to FIG. 3A, the digital card game graphical user interface (GUI) 300 comprises a banner 310 in which the M.U.S.E. name is shown and meanings of the acronym are prominently displayed, along with an avatar card 312 for an actual entity or player, e.g., subject matter expert (SME). The player, represented by the avatar card 312 is associated with various Guidance, Risk, & Project cards, displayed as their respective cards in the hand 320 and status banner 330 portions of the GUI. The player's status 340 is shown in the left column, including the phase of the turn, along with the Guidance, Momentum, & Focus points, as well as the current game Score and Turns remaining. The lower left corner 350 is a clickable action based on the phase to “draw,” “advance,” or “discard,” depending on the phase (where the “draw” action is depicted in FIG. 3A).

There are two horizontally scrollable sets of cards, i.e., the player's “hand” 320 on the bottom, and the player's “status” 330 of played cards above them. This provides a high-level method to observe a hypothetical enterprise's overall cyber security & resiliency structure at a glance: it includes items being considered, risks identified, projects completed, and lists points of reference leveraged along the way. Sets of highlighted and non-highlighted locks 360 that appear just below the respective letters of M.U.S.E. will indicate progress toward established mitigations and defense-in-depth.

The game mechanics support solo play with a goal of maximizing the score in a set of number of turns, which encourages multiple rounds of gamified education with regard to platform-independent risk, platform-specific mitigation, where to find guidance in clarifying that risk, and the momentum to implement the improvements. This gameplay momentum can then drive real momentum in implementing real projects to further mitigate real risk on actual platforms. The gameplay and educational benefits of pairing platform-specific projects with platform-independent risk emphasizes the nature of all cyber security and resiliency projects to be business decisions in mitigating specific risks. The game's integration of online reference material aids in the discovery and depth of understanding associated with those mitigations' value. This game's design simplifies a holistic look at security in order to continuously drive further improvements in real enterprises' respective overall security postures.

With reference now to FIG. 3B, the integration of the M.U.S.E. Cues digital card game with an anonymous leaderboard platform in accordance with one or more illustrative embodiments will now be further described. FIG. 3B shows an example of progress elements acquired by a player of the M.U.S.E. Cues digital card game. These progress elements 302, 306 are actual digital cards acquired by the player for accomplishing various tasks within the M.U.S.E. Cues digital card game. For example, the progress element 302 is achieved by the player reaching level 5 of the M.U.S.E. Cues digital card game. The progress element 306 is achieved by the player scoring more than 100 points in a single game of the M.U.S.E. Cues digital card game. The criteria for achieving these progress elements is shown at the bottom of the digital card representations of the progress elements 302, 306.

Associated with each of these progress elements 302, 306 is a corresponding static NFT 304, 308 that is generated through the anonymous leaderboard platform mechanisms described previously, e.g., by the NFT generator 105 in the anonymous leaderboard platform 100 in FIG. 1. The static NFTs 304, 308 comprise a tuple of characteristic data including a unique identifier of the instance of the progress element, e.g., “sNFT1c1056” and “sNFT1c1002”, a timestamp of when the progress element was achieved, acquired, assigned, awarded or otherwise associated with the entity corresponding to the dynamic NFT 300, and a rarity or frequency of association of this type of progress element to entities within the monitored computing environment, e.g., how many instances of this progress element are associated or “owned” by entities (e.g., in the depicted example this value is “4” for progress element 302). The static NFTs 304, 308 form a blockchain where each subsequent block is linked to the previous block in the blockchain. The fact that the user's dynamic NFT is made up of the achievements earned through playing the game as represented by static NFTs is further represented by the “User Dynamic NFT” string at the top of the Figure which comprises the unique identifiers of each static NFT, its timestamp, and the number of instances of the progress element.

FIG. 3C shows another example of a dynamic NFT 370 and its correlation with an entry 384 in an anonymous leaderboard output 380. As shown in FIG. 3C, the dynamic NFT 370 comprises a blockchain having an initial block with an encrypted identifier of the user 371 and a chain of blocks corresponding to static NFTs 372-379. These static NFTs 372-379 are generated for different progress elements associated with the user in response to the user satisfying requirements of different achievements within the M.U.S.E. Cues digital card game, such as achieving levels, e.g., levels 3-5, scoring more than 100 points in a single game, performing 10 M category mitigations, etc. Each static NFT and corresponding block is linked to the previous block in the blockchain, thereby generating an immutable record of the progress elements associated with the entity, e.g., user or player of the game. These are linked back to the initial block 371 which specifies the encrypted identity of the entity.

As shown in FIG. 3C, the encrypted identity specified in the dynamic NFT is used to generate a corresponding entry 384 in the anonymous leaderboard output 380. Each entry has an corresponding anonymous identity, e.g., “[encryptedUserID 382]” which cannot be decrypted by anyone that does not have the appropriate encryption token. However, individual entities will know their own encrypted identity can view the anonymous leaderboard 380 to determine their relative ranking to other entities, e.g., the entity associated with anonymous identifier “[encryptedUserID 382]” can see their score and relative ranking to other entities and determine that they are currently ranked 4^{th} highest on the anonymous leaderboard 380. This provides an incentive to the entity to play the M.U.S.E. Cues digital card game to achieve other progress elements and a higher score so that they can rank more highly in the anonymous leaderboard. At the same time, this anonymization avoids unwanted knowledge of the true identity of the entity. If desired, the entity can request that their identity be revealed in the leaderboard 380 by providing the corresponding encryption token so that their encrypted identifier can be decrypted in which case the leaderboard entry 384 would then reflect the entities unencrypted identity.

As described above, the illustrative embodiments of the present invention are specifically directed to an improved computing tool that automatically generates and manages an anonymous leaderboard for a monitored computing environment and with regard to progress elements associated participants in one or more monitored activities. All of the functions of the illustrative embodiments as described herein are intended to be performed using automated processes without human intervention. While a human being may be the subject of the operations performed, e.g., the progress elements achieved by a human being (user) or organization of human beings may be the entities for which progress elements and leaderboard rankings may be generated, the illustrative embodiments of the present invention are not directed to actions performed by the human being(s), but rather logic and functions performed specifically by the improved computing tool on the medical images taken of the patient. Moreover, even though the present invention may provide an output of an anonymized leaderboard and provide a querying mechanism for accessing the NFTs associated with entities represented in the anonymized leaderboard, which ultimately assists human beings and incentivizes human beings/organizations to achieve additional progress to rank more highly relative to other human beings/organizations, the illustrative embodiments are not directed to human performed actions, but rather to the specific operations performed by the specific improved computing tool of the present invention which improves existing digital or computer managed leaderboards and improves and promotes positive competition between users/organizations while maintaining privacy of the participants. Thus, the illustrative embodiments are not organizing any human activity, but are in fact directed to the automated logic and functionality of an improved computing tool.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as computer managed anonymous leaderboard operations for relative ranking of entities based on progress elements associated with these entities while maintaining privacy of the real-world identities of the entities represented in the leaderboard, which involves implementation of the computer managed anonymous leaderboard platform 100 in FIG. 1. In addition to block 100, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 200, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

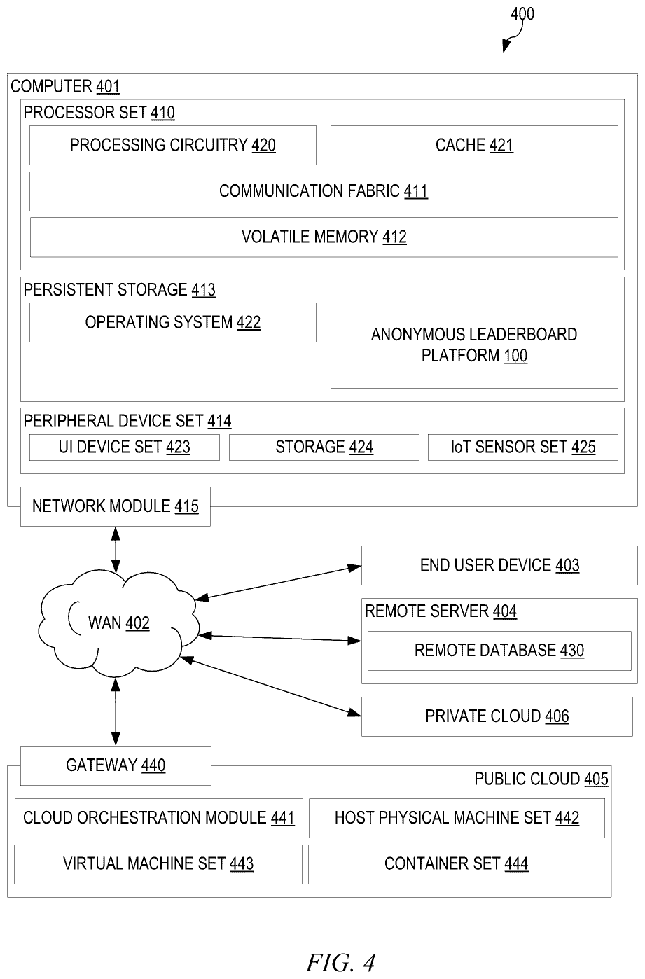

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 200 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in block 200 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

As shown in FIG. 4, one or more of the computing devices, e.g., computer 401 or remote server 404, may be specifically configured to implement an anonymous leaderboard platform, such as anonymous leaderboard platform 100 in FIG. 1, for example. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 401 or remote server 404, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described herein, the implementation of the mechanisms of the illustrative embodiments improves the functionality of the computing device and provides a useful and concrete result that facilitates generation, modification or updating, and management of anonymous leaderboards for various types of monitored computing environments. The anonymous leaderboard operations/functionality improve upon existing computer managed leaderboards by preventing unwanted identification of true identities of entities represented in the leaderboard, while providing an immutable record of the entities and immutable verification mechanism for verifying the true identity of an anonymized entity in the leaderboard.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for providing an anonymous leaderboard for a monitored computing environment, the method comprising:
generating, in response to an entity registering with the monitored computing environment, an encrypted identity for the registered entity;
generating a dynamic non-fungible token (NFT) for the registered entity, wherein the dynamic NFT has an associated blockchain technology data structure;
associating the blockchain technology data structure with the encrypted identity;
receiving a progress element notification from the monitored computing environment in response to the entity satisfying criteria for a predefined progress element associated with the monitored computing environment;
generating, in response to receiving the progress element notification, a static NFT corresponding to the predefined progress element and storing the static NFT as a block in the blockchain technology data structure; and
generating an entry in an anonymous leaderboard output based on the blockchain technology data structure of the dynamic NFT, wherein the entry identifies the entity by the encrypted identity.

2. The method of claim 1, wherein associating the blockchain technology data structure with the encrypted identity comprises generating an initial block in the blockchain technology data structure as a static NFT storing the encrypted identity.

3. The method of claim 2, wherein the static NFT corresponding to the predefined progress element is linked to a previous block in the blockchain technology data structure, and wherein in response to the static NFT being a first static NFT, the static NFT is linked to the initial block in the blockchain technology data structure.

4. The method of claim 1, wherein the monitored computing environment a user experience system and the progress element notification is based on actions performed by the user with the user experience system, and wherein the criteria for the predefined progress element represents a user achieving a predetermined goal within the user experience system.

5. The method of claim 4, wherein the user experience system is an electronically rendered game, and wherein the predefined progress element comprises an achievement within the electronically rendered game with regard to the user acquiring game elements or performing interactions with game elements.

6. The method of claim 1, wherein the monitored computing environment is one of:
a computing environment of an employer, wherein the predefined progress element comprises at least one of skill sets, educational certifications, skill certifications, or workplace goal achievements that are associated with employees of the employer, or
a computing environment of an educational institution, wherein the predefined progress element comprises at least one of a score on an educational task, or and educational achievement.

7. The method of claim 1, wherein the static NFT comprises a timestamp indicating a time when the user achieved the corresponding progress element and a rarity characteristic specifying a rarity measure based on how often other users have achieved the corresponding progress element.

8. The method of claim 1, wherein the entry in the anonymous leaderboard output is positioned relative to other entries in the anonymous leaderboard output corresponding to other users based on a scoring of first static NFTs present in the blockchain technology data structure and scoring of second static NFTs of other blockchain technology data structures of other users.

9. The method of claim 8, wherein the scoring of the first static NFTs and the second static NFTs is based on rarity measures of the first static NFTs and second static NFTs, wherein static NFTs that are relatively more rare than other static NFTs are scored relatively higher.

10. The method of claim 1, further comprising:
in response to receiving the progress element notification, updating a global progress element characteristics data structure for the progress element based on the progress element notification, wherein the updating modifies at least one global measure of a rarity of the progress element, and wherein generating the static NFT comprises storing, in the static NFT, an indicator of a rarity of the static NFT based on the global progress element characteristics data structure.

11. A computer program product comprising a computer readable storage medium having a computer readable program stored therein, wherein the computer readable program, when executed on a computing device, causes the computing device to:
generate, in response to an entity registering with the monitored computing environment, an encrypted identity for the registered entity;
generate a dynamic non-fungible token (NFT) for the registered entity, wherein the dynamic NFT has an associated blockchain technology data structure;
associate the blockchain technology data structure with the encrypted identity;
receive a progress element notification from the monitored computing environment in response to the entity satisfying criteria for a predefined progress element associated with the monitored computing environment;
generate, in response to receiving the progress element notification, a static NFT corresponding to the predefined progress element and storing the static NFT as a block in the blockchain technology data structure; and
generate an entry in an anonymous leaderboard output based on the blockchain technology data structure of the dynamic NFT, wherein the entry identifies the entity by the encrypted identity.

12. The computer program product of claim 11, wherein associating the blockchain technology data structure with the encrypted identity comprises generating an initial block in the blockchain technology data structure as a static NFT storing the encrypted identity.

13. The computer program product of claim 12, wherein the static NFT corresponding to the predefined progress element is linked to a previous block in the blockchain technology data structure, and wherein in response to the static NFT being a first static NFT, the static NFT is linked to the initial block in the blockchain technology data structure.

14. The computer program product of claim 11, wherein the monitored computing environment a user experience system and the progress element notification is based on actions performed by the user with the user experience system, and wherein the criteria for the predefined progress element represents a user achieving a predetermined goal within the user experience system.

15. The computer program product of claim 14, wherein the user experience system is an electronically rendered game, and wherein the predefined progress element comprises an achievement within the electronically rendered game with regard to the user acquiring game elements or performing interactions with game elements.

16. The computer program product of claim 11, wherein the monitored computing environment is one of:
a computing environment of an employer, wherein the predefined progress element comprises at least one of skill sets, educational certifications, skill certifications, or workplace goal achievements that are associated with employees of the employer, or
a computing environment of an educational institution, wherein the predefined progress element comprises at least one of a score on an educational task, or and educational achievement.

17. The computer program product of claim 11, wherein the static NFT comprises a timestamp indicating a time when the user achieved the corresponding progress element and a rarity characteristic specifying a rarity measure based on how often other users have achieved the corresponding progress element.

18. The computer program product of claim 11, wherein:
the entry in the anonymous leaderboard output is positioned relative to other entries in the anonymous leaderboard output corresponding to other users based on a scoring of first static NFTs present in the blockchain technology data structure and scoring of second static NFTs of other blockchain technology data structures of other users,
the scoring of the first static NFTs and the second static NFTs is based on rarity measures of the first static NFTs and second static NFTs, and
static NFTs that are relatively more rare than other static NFTs are scored relatively higher.

19. The computer program product of claim 11, further comprising:
in response to receiving the progress element notification, updating a global progress element characteristics data structure for the progress element based on the progress element notification, wherein the updating modifies at least one global measure of a rarity of the progress element, and wherein generating the static NFT comprises storing, in the static NFT, an indicator of a rarity of the static NFT based on the global progress element characteristics data structure.

20. An apparatus comprising:
at least one processor; and
at least one memory coupled to the at least one processor, wherein the at least one memory comprises instructions which, when executed by the at least one processor, cause the at least one processor to:
generate, in response to an entity registering with the monitored computing environment, an encrypted identity for the registered entity;
generate a dynamic non-fungible token (NFT) for the registered entity, wherein the dynamic NFT has an associated blockchain technology data structure;
associate the blockchain technology data structure with the encrypted identity;
receive a progress element notification from the monitored computing environment in response to the entity satisfying criteria for a predefined progress element associated with the monitored computing environment;
generate, in response to receiving the progress element notification, a static NFT corresponding to the predefined progress element and storing the static NFT as a block in the blockchain technology data structure; and
generate an entry in an anonymous leaderboard output based on the blockchain technology data structure of the dynamic NFT, wherein the entry identifies the entity by the encrypted identity.
